(19) United States
(12) Patent Application Publication
(10) Pub. No.: US 2005/0060659 A1
(43) Pub. Date: Mar. 17, 2005

(54) System, method and software for communicating the effects of user preference settings in an information handling system

(75) Inventors: Gary J. Verdun, Belton, TX (US); Richard W. Schuckle, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/659,880

(22) Filed: Sep. 11, 2003

(51) Int. Cl. G06F 3/00

(52) U.S. Cl. 715/772; 715/764

(57) ABSTRACT

The present disclosure describes a system, method and software for informing an information handling system user as to the effect or consequences of changing operational characteristics of an information handling system component. In particular, the present disclosure provides a method for communicating the effects of user preference settings in an information handling system. The method provides for the display of a component control for a selected component operable to effect a user preference setting concerning the selected component. The method also provides for the display of an operating status for a component related to the selected component, the operating status resulting from effecting the user preference setting on the selected component. As a result, when a user changes one or more operational aspects of a component, the user is presented with the consequences of such changes on the operating status of related system components.

### TECHNICAL FIELD

The present disclosure relates generally to information handling systems and, more particularly, to information handling system configuration and utilization tools.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To enhance the usability of information handling systems, many operating system providers include in their designs information handling system custom configuration capabilities. For example, many operating systems permit users to create custom power management schemes, control hardware acceleration, vary screen resolution, expand color palettes, as well as modify other aspects of information handling system performance and operation. The ability to customize various system performance parameters is particularly prevalent in the area of notebook or portable computers.

Despite the long history of availability of such customization capabilities, the actual effects of a user's customization remains unknown to many customizing users. Consequently, upon implementing various changes to their systems, many users unknowingly sacrifice performance in important aspects of system operation while enhancing performance in less important aspects. In the end, a user is unlikely to achieve precisely the desired results from their user preference settings. Further, the primary manner in which most users may even approach their desired results is through luck or extensive trial and error.

### SUMMARY

In accordance with teachings of the present disclosure, a method for communicating the consequences of a user preference setting on related components in an information handling system is described. The method preferably includes displaying a component control for a selected component. The component control is preferably operable to effect a user preference setting concerning the selected component. The method preferably also includes displaying an operating status for a component related to the selected component. The displayed operating status of the related component is preferably the operating status of the related component resulting from effecting the user preference setting on the selected component.

Also in accordance with teachings of the present disclosure, an information handling system operable to communicate the effects of user preference settings on related components is described. The information handling system preferably includes a memory, a processor operably coupled to the memory and a plurality of components operably coupled to the memory and the processor. Each component preferably has an associated operating status. The information handling system preferably also includes a display device operably coupled to the memory and the processor and a program of instructions storable in the memory and executable by the processor. The program of instructions is preferably operable to display the operating status for a first component and receive a desired modification in operation for the first component. The program of instructions preferably also determines the operating status for each operationally linked component resulting from the modification in operation for the first component and displays, on the display device, the operational status for the first component and at least one operationally linked component.

Further, in accordance with teachings of the present disclosure, a computer program, stored on a tangible storage medium, for use in communicating the effects of user preference settings in an information handling system is described. The program includes executable instructions that may cause a computer to define relationships between a plurality of information handling system components. Further, the executable instructions may also display at least one performance control operable to effect at least one desired change in operation of a configurable information handling system component. The executable instructions preferably also cause the computer to receive, through the at least one performance control, a desired change in operation of the configurable information handling system component. The executable instructions preferably further cause the computer to calculate, based on the defined relationships, effects on one or more related information handling system components. The effects are those resulting from the desired change in operation of the configurable information handling system component. Further, the executable instructions may cause the computer to display an operating status for the related information handling system components resulting from effecting the desired change.

In one aspect, the present disclosure provides the technical advantage of increasing the effectiveness of user information handling system customization.

In another aspect, the present disclosure provides the technical advantage of communicating to users the effects of changes to various information handling system settings as well as the interrelation of various information handling system performance parameters and associated components.

In still another aspect, the present disclosure enables users to calculate the trade-offs that arise from changing various aspects of information handling system as well as information handling system component performance.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram depicting an exemplary embodiment of an information handling system, according to teachings of the present disclosure;

FIG. 2 is a flow diagram depicting a method for communicating the effects of user preference settings in an information handling system, according to teachings of the present disclosure;

FIG. 3 is a flow diagram depicting an alternate embodiment of a method for communicating the effects of user preference settings in an information handling system, according to teachings of the present disclosure; and

FIG. 4 is a block diagram depicting an exemplary embodiment of a graphical user interface for communicating the effects of user preference settings in an information handling system, according to teachings of the present disclosure.

### DETAILED DESCRIPTION

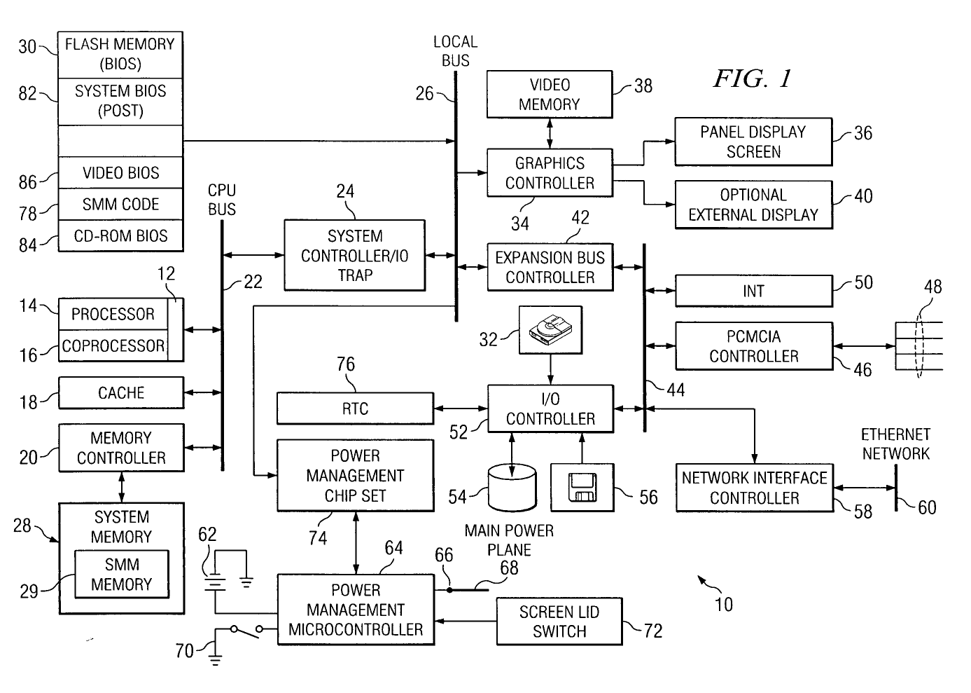

Preferred embodiments and their advantages are best understood by reference to FIGS. 1 through 4, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

As referred to herein, a component of an information handling system may assume a variety of forms. In one aspect, a component of an information handling system may include a single hardware device such as a hard drive, floppy disk drive, CPU, etc. In another aspect, a component of an information handling system may include a single software module such as the software pertaining to system virtual memory, display management, etc. Further, a component of an information handling system may include a plurality of hardware devices, a plurality of software modules, or a combination of hardware devices and software modules.

Referring first to FIG. 1, a block diagram of an information handling system is shown, according to teachings of the present invention. Information handling system or computer system 10 preferably includes at least one microprocessor or central processing unit (CPU) 12. CPU 12 may include processor 14 for handling integer operations and coprocessor 16 for handling floating point operations. CPU 12 is preferably coupled to cache 18 and memory controller 20 via CPU bus 22. System controller I/O trap 24 preferably couples CPU bus 22 to local bus 26 and may be generally characterized as part of a system controller.

Main memory 28 of dynamic random access memory (DRAM) modules is preferably coupled to CPU bus 22 by a memory controller 20. Main memory 28 may be divided into one or more areas such as system management mode (SMM) memory area 29.

Basic input/output system (BIOS) memory 30 is also preferably coupled to local bus 26. FLASH memory or other nonvolatile memory may be used as BIOS memory 30. A BIOS program (not expressly shown) is typically stored in BIOS memory 30. The BIOS program preferably includes software which facilitates interaction with and between information handling system 10 boot devices such as a keyboard (not expressly shown), a mouse (not expressly shown), or CD-ROM 32. BIOS memory 30 may also store system code operable to control a plurality of basic information handling system 10 operations.

Graphics controller 34 is preferably coupled to local bus 26 and to panel display screen 36. Graphics controller 34 may also be coupled to video memory 38 operable to store information to be displayed on panel display 36. Panel display 36 is typically an active matrix or passive matrix liquid crystal display (LCD), however, other display technologies may be employed. In selected applications, uses or instances, graphics controller 34 may also be coupled to an optional, external display or standalone monitor display 40.

Bus interface controller or expansion bus controller 42 preferably couples local bus 26 to expansion bus 44. In one embodiment, expansion bus 44 may be configured as an Industry Standard Architecture (“ISA”) bus. Other buses, for example, a Peripheral Component Interconnect (“PCI”) bus, may also be used.

Personal computer memory card international association (PCMCIA) controller 46 may also be coupled to expansion bus 44 as shown. PCMCIA controller 46 is preferably coupled to a plurality of expansion slots 48. Expansion slots 48 may be configured to receive PCMCIA expansion cards such as modems, fax cards, communications cards, and other input/output (I/O) devices.

Interrupt request generator 50 is also preferably coupled to expansion bus 44. Interrupt request generator 50 is preferably operable to issue an interrupt service request over a predetermined interrupt request line in response to receipt of a request to issue interrupt instruction from CPU 12.

I/O controller 52, often referred to as a super I/O controller, is also preferably coupled to expansion bus 44. I/O controller 52 preferably interfaces to integrated drive electronics (IDE) hard drive 54, CD-ROM (compact disk-read only memory) drive 32 and floppy disk drive 56. Other disc drive devices (not expressly shown) which may be interfaced to the I/O controller include a removable hard drive, a zip drive, a CD-RW (compact disk-read/write) drive, and a CD-DVD (compact disk-digital versatile disk) drive.

Network interface controller 58 is preferably provided and enables information handling system 10 to communicate with communication network 60, e.g., an Ethernet network. Communication network 60 may include a local area network (“LAN”), wide area network (“WAN”), Internet, Intranet, wireless broadband or the like. Network interface controller 58 preferably forms a network interface for communicating with other information handling systems (not expressly shown) coupled to communication network 60. An information handling system's communication components generally include hardware as well as software components. Examples of hardware components include network interface controller 58 and communication network 60. Examples of software components include messaging services and network administration services.

As illustrated, information handling system 10 preferably includes power supply 62, which provides power to the many components and/or devices that form information handling system 10. Power supply 62 may be a rechargeable battery, such as a nickel metal hydride (“NiMH”) or lithium ion battery, when information handling system 10 is embodied as a portable or notebook computer.

Power supply 62 is preferably coupled to power management microcontroller 64. Power management microcontroller 64 preferably controls the distribution of power from power supply 62. More specifically, power management microcontroller 64 preferably includes power output 66 coupled to main power plane 68 which supplies power to CPU 12. Power management microcontroller 64 may also be coupled to a power plane (not expressly shown) operable to supply power to panel display 36.

Power management microcontroller 64 preferably monitors the charge level of power supply 62 to determine when and when not to charge battery 62. Power management microcontroller 64 is preferably also coupled to main power switch 70, which the user actuates to turn information handling system 10 on and off. While power management microcontroller 64 powers down one or more portions or components of information handling system 10, e.g., CPU 12, panel display 36, or hard drive 54, when not in use to conserve power, power management microcontroller 64 itself is preferably substantially always coupled to a source of power, preferably power supply 62.

In a portable embodiment, information handling system 10 may also include screen lid switch 72 or indicator 72 which provides an indication of when panel display 36 is in an open position and an indication of when panel display 36 is in a closed position. It is noted that panel display 36 may be located in the same location in the lid (not expressly shown) of the computer as is typical for “clamshell” configurations of portable computers such as laptop or notebook computers. In this manner, panel display screen 36 may form an integral part of the lid of the system, which swings from an open position to permit user interaction to a closed position.

Computer system 10 may also include power management chip set 74. Power management chip set 74 is preferably coupled to CPU 12 via local bus 26 so that power management chip set 74 may receive power management and control commands from CPU 12. Power management chip set 74 is preferably connected to a plurality of individual power planes (not expressly shown) operable to supply power to respective components of information handling system 10, e.g., hard drive 54, floppy drive 56, etc. In this manner, power management chip set 74 preferably acts under the direction of CPU 12 to control the power supplied to the various power planes and components of a system.

Real-time clock (RTC) 76 may also be coupled to I/O controller 52 and power management chip set 74. Inclusion of RTC 76 permits timed events or alarms to be transmitted to power management chip set 74. Real-time clock 76 may be programmed to generate an alarm signal at a predetermined time as well as to perform other operations.

When information handling system 10 is turned on or powered up, information handling system 10 preferably enters a start up phase, also referred to as a boot up phase, during which the available computer system hardware may be detected and the operating system loaded. During the initial boot stage, BIOS software stored in non-volatile BIOS memory 30 may be copied into main memory 28 to provide for quick execution. This technique may be referred to as shadowing or shadow RAM. At this time, SMM code 78 may be copied into the system management mode memory area 29 of main memory 28. CPU 12 preferably executes SMM code 78 after CPU 12 receives a system management interrupt (SMI) which causes the microprocessor to enter SMM. It is noted that along with SMM code 78, also preferably stored in BIOS memory 30 and copied into main memory 28 at power up are system BIOS 82, including a power on self test module(POST), CD-ROM BIOS 84 and video BIOS 86. Alternative memory mapping schemes may also be used. For example, SMM code 78 may be stored in a fast SRAM memory (not expressly shown) coupled to CPU bus 22.

In the operating system (OS) employed on many information handling systems, an ability to tailor the actions of many of the hardware and software components are included. By reconfiguring a user preference setting for a hardware or software component, a user is able to specify generally how the hardware or software component will act each time it is used thereafter. In a simple example, a user can set a screensaver to begin after a certain period of information handling system 10 inactivity. In other examples, a user can tell the system how much resources to commit to a desktop recycle bin or how much memory should be allocated to a system's virtual memory usage.

In other applications, the level at which a user can set their preference settings can be much more complex. In such systems, the user preference settings may be implemented through the OS, through a BIOS application, as well as through other components or combinations. In such complex systems, a user may be able to adjust the clock speed of the system's CPU, the temperature at which the system fan is to turn on or which the CPU is not permitted to exceed, as well as a number of other system parameters.

In certain aspects of an information handling system's operation, a change in performance of one component may have a necessary effect on one or more related or operationally linked components. For example, maximizing a performance component of a portable information handling system 10, e.g., clocking the CPU at its highest rate, setting the display at peak resolution and brightness, etc., will likely affect the life of battery 62 of the system as such a setting will require more power to be delivered to the components. Further, operating the system at peak performance is likely to cause more heat to be generated which in turn is likely to cause the system fan (not expressly shown) to operate more frequently and for longer periods of time. The fan's operation is subsequently likely to cause the system to generate more noise than if the system were operating at a reduced speed. As such, the performance, temperature, noise, and battery life components of the described system may be described as related or operationally linked.

In light of this complexity, a method, system and software are needed to inform users of the effects and consequences of initiating seemingly simple or clearly complex user preference settings.

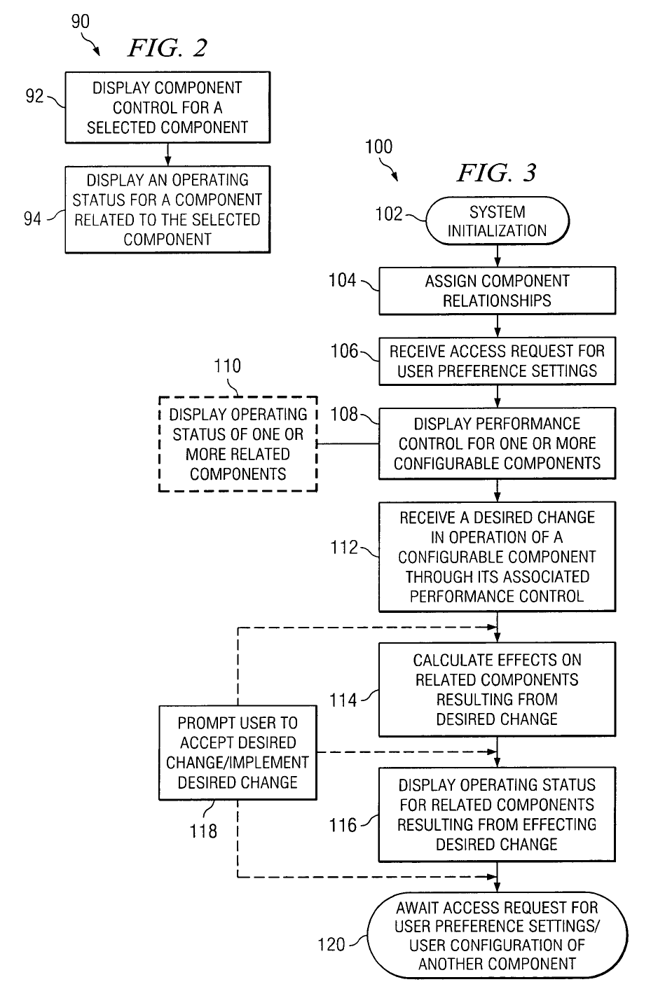

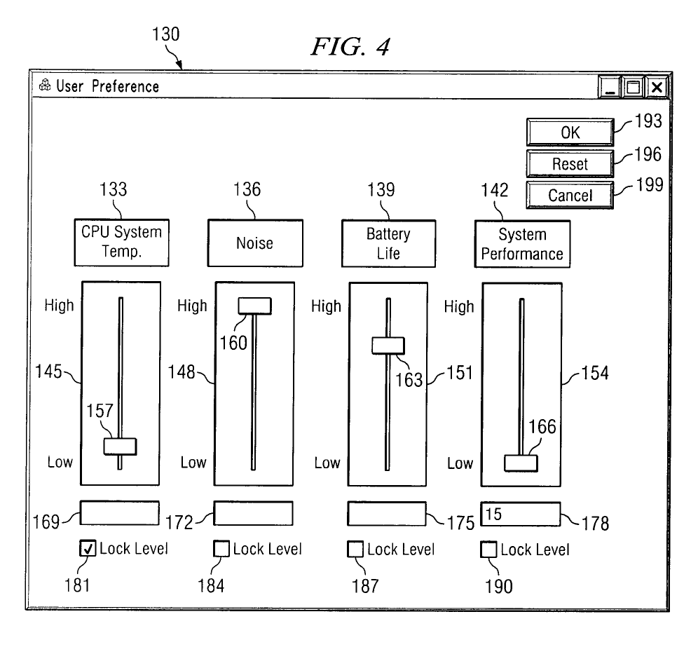

Referring now to FIG. 2, a flow diagram of an exemplary embodiment of a method for communicating the effects of user preference settings in an information handling system is shown, according to teachings of the present disclosure. In general, method 90 of FIG. 2 preferably begins at 92 with the display of one or more component controls by information handling system 10. A component control, for example, may be available for adjusting the overall performance of information handling system 10, for adjusting the desired life of power supply or battery 62, for adjusting one or more operational aspects or characteristics of graphics controller 34 or panel display screen 36, as well as for adjusting a variety of other operating characteristics for the many components, devices and software modules (not expressly shown) preferably included in information handling system 10. Additional detail regarding component control funtionality and operation is discussed in greater detail below with respect to FIG. 3 and FIG. 4.

In addition to facilitating the display of one or more component controls at step 92, method 90 preferably also provides for the display of the operational or operating status for one or more components related or operationally linked to the component associated with the displayed component control. In the area of power management, for example, the amount of power consumed by battery 62 and therefore the estimated life of battery 62 may be directly related to an overall information handling system 10 performance level user preference setting. More particularly, if a user were to intend information handling system 10 to be used in a gaming or DVD (Digital Versatile Disk) viewing mode, for example, information handling system 10 would preferably be set to perform at an increased level which generally would thereby cause the life of battery 62 to more rapidly decrease. Additional detail regarding the relationships among the components of information handling system 10 as well as the display of the operating status or one or more operational characteristics of the related or operationally linked components is discussed in greater detail below with respect to FIGS. 3 and 4.

Referring now to FIG. 3, an alternate embodiment of a method for communicating the effects of user preference settings in an information handling system is shown, according to teachings of the present disclosure. As illustrated in FIG. 3, method 100 preferably begins at 102, upon system initialization. Alternatively, method 100 may be initiated at the request of a user, as part of regularly scheduled information handling system 10 maintenance, or at some other period. Upon the initiation of method 100 at 102, method 100 preferably proceeds to 104.

At 104, method 100 preferably assigns or defines the relationships or operational links between two or more components of information handling system 10. In one embodiment, the assignment or defining of component relationships at 104 may flow from user-provided definitions. For example, a user may define a relationship or operational link demanding that aspects of information handling system 10 performance, battery life, internal temperature, and noise be interrelated.

In another embodiment, the relationships or operational links between two or more components may be established from the observed operation of information handling system 10. For example, it may be observed that during operation of information handling system 10, as the performance of CPU 12 is heightened, the life of power supply or battery 62 decreases. As such, the relationship between CPU 12 performance and battery life 62 may be defined based on the observed historical operational interaction of two or more components of information handling system 10. Once the device or component relationships have been assigned, defined or otherwise established at 104, method 100 preferably proceeds to 106.

Prior to or as a part of 106, depending on the implementation, method 100 may remain in a wait state for a user request to view, access or manipulate the user preference settings for one or more components of information handling system 10. In other embodiments, a user may be presented with a user preference settings window during initial configuration of information handling system 10, at sign-on of a new user, as well as other selected times. Upon receipt of an access request for the user preference settings of information handling system 10 at 106, method 100 preferably proceeds to 108.

At 108, method 100 preferably facilitates or effects the display of a component control for one or more selected components of information handling system 10. For example, a component control associated with a power supply or battery component may be displayed upon a user request to adjust the desired life of battery 62. According to teachings of the present disclosure, a component control may come in a variety of forms including, but not limited to, sliders, dials, numeric operating capacity entry windows (such as a percentage of full operating capacity), as well as others.

In one aspect, the component controls displayed at 108 are preferably associated with one or more configurable information handling system 10 components. For example, a component control associated with one or more operational aspects of central processing unit 12 may be displayed. Further, the component control associated with central processing unit 12 is preferably operable to adjust one or more operational aspects of central processing unit 12, such as stepping down, or reducing, the clock speed of central processing unit 12.

In another aspect, a component control associated with power supply or the battery 62 may be provided. Such a component control may be configured to adjust the amount of power permitted to be consumed from battery 62 by the various components of information handling system 10. It is contemplated that information handling system 10 may be designed such that each component thereof may be configured by a user in one or more respects. In such a case, method 100, at 108, may display a performance control for one or more of a plurality of the components preferably included in information handling system 10.

The component controls displayed at 108 may be determined in a variety of ways. In one aspect, the user may select the component controls to be displayed from a menu of available component controls, e.g., a menu including power component controls, performance component controls, appearance component controls, etc. In another aspect, a user may configure information handling system 10, or an OS operating thereon, to display a default set of one or more component controls upon each user request to adjust preference settings thereafter. A default option may provide the user with access to additional component controls through a series of one or more menus. Other implementations of presenting one or more component controls upon request are contemplated within teachings of the present disclosure.

As indicated at 110, in one embodiment of method 100, display of the operating status of one or more related or operationally linked components may be effected substantially simultaneously with the display of one or more component controls at 108. Alternatively, display of an operating status for one or more related components may be effected after the display of one or more component controls at 108. For example, as illustrated in FIG. 4, information handling system 10 may be configured such that its overall system performance is related to its battery life, noise level and temperature. In response to a user access request for the performance component control, at steps 108 and 110, a component control for information handling system 10 performance may simultaneously be displayed with a component control or a combined component control/operating status indicator for the related components of battery life, noise level and temperature. The timing of display of the operating status for the one or more components related to the component selected for review or adjustment may be alternatively implemented without departing from the spirit, scope and teachings of the present disclosure.

At 112, method 100 is preferably in a state where it may receive a desired change in operation of a configurable component through the configurable component's associated component control. For example, a user wishing to preserve battery life may manipulate a slider associated with one or more power management functions implemented in the software or hardware of information handling system 10, to effect such a change. Upon receipt of a desired change in an operational characteristic of a configurable component at 112, method 100 preferably proceeds to 114.

At 114, method 100 preferably calculates or determines the effects on the components related to the reconfigured, configurable component resulting from implementing or effecting the desired change in operation of the configurable component. For example, according to a user definition provided at 104, where component relationships were assigned, it may be defined that as information handling system performance 10 is reduced, the life of battery 62 of information handling system 10 is extended proportionately. In another example, if information handling system 10 is designed such that a user may limit the temperature at which information handling system 10 or a device or component thereof operates, a reduction in the permitted operating temperature of information handling system 10 may result in the performance of information handling system 10 being simultaneously reduced, i.e., performance of information handling system 10 and temperature of information handling system 10 are defined as related or operationally linked in such a design. Once the effects of implementing or effecting a desired change in operation of a configurable component have been calculated or determined, method 100 preferably proceeds to 116.

At 116, method 100 preferably displays the operating status for the related components resulting from effecting the desired change in operation of the configurable component. In an embodiment of method 100 where the operating status of one or more components related to the selected component control is displayed, as discussed above with respect to 108 and 110, method 100, at 116, may update the existing or previously displayed operating status to reflect the new, resulting operating status. In an embodiment of method 100 where only a component control for one or more configurable components was displayed at 108, method 100 may effect the initial display of an operating status for one or more components related thereto, the operating status being that resulting from implementation of the desired change in operation of the component associated with the displayed component control.

After displaying the effects of the user preference setting on the affected components, as indicated at 118, method 100 may prompt the user to accept the change in operation of the selected component. Alternatively, once a user manipulates a component control associated with a selected component, method 100 may automatically implement the desired change in component operation through, for example, communicating with a controller associated with the configurable component. Such a controller, operable to affect the operation of an associated component in accordance with a user preference setting, may be included as a part of a selected component, as one or more software modules, as well as through other mechanisms. As illustrated, prompting the user to accept a desired change or automatically implementing a desired change may be incorporated into method 100 after 112 where a desired change in operation of the configurable component is first received, after 114 where the effects on related components resulting from a desired change have been determined or calculated, or after 116 where the operating status of the components resulting from effecting the desired change have been displayed to the user.

Once the desired change in operation of the configurable component has been accepted and/or implemented, method 100 preferably proceeds to 120 where information handling system 10 may await an additional request for access to the user preference settings of information handling system 10 before returning to 108. Alternatively, at 120, information handling system 10 may await user input of another user preference setting for the same or a different component of information handling system 10. Should the user wish to change one or more operational characteristics of a selected component at 120, method 100 may return to 108 where method 100 preferably proceeds as described above.

Referring now to FIG. 4, a block diagram illustrating one embodiment of a component control and operating status graphical user interface display for a plurality of information handling system 10 components is shown, according to teachings of the present disclosure. Contained in graphical user interface 130 are combined component control/operating status displays for related components of information handling system 10 including CPU temperature 133, system noise 136, battery life 139 and system performance 142. Associated with each of components 133, 136, 139 and 142 depicted in graphical user interface 130 are operating status/component controls 145, 148, 151 and 154.

In one embodiment, one or more of operating status/component controls 145, 148, 151 and 154 may be configured such that movement of a slider 157, 160, 163 or 166 enables a user to communicate and implement a user preference setting or desired change in operation of a component. For example, user repositioning of slider 157 may enable the user to dictate the temperature at which CPU 12 operates. In addition, the final position of slider 157 may be employed to inform the user of the resulting operating status of the reconfigured component, here the operating temperature of CPU 12 as reflected by CPU temperature component 133. Hash marks and high-low indicators may also be provided to communicate to the user a change in operation being requested and/or the resulting operating status for the associated component.

As mentioned above, one or more value entry options designed to permit a user to enter numeric or selected values representing a user preference setting for a component may be included. Examples of such value entry options are illustrated in FIG. 4 as windows 169, 172, 175 and 178. In one implementation, a user entering a value in one or more of windows 169, 172, 175 or 178 may result in its associated slider, 157, 160, 163 and 165, respectively, being repositioned to reflect the numeric value's position within the high-low range. For example, in window 178 a value of fifteen (15) is shown. The value fifteen (15) may indicate that the performance component of information handling system 10 is in its most reduced state e.g., operating at fifteen percent (15%) of its full potential. In an alternate implementation, slider 172 in operating status/component control area 154 may also be positioned at the low mark of the high-low range to indicate that system performance component 142 of information handling system 10 is set at its lowest value. Window 178 may also be configured to permit user preference settings affecting the clock speed of CPU 12. For example, a user might be able to enter a value of one and four-tenths (1.4) to direct system performance component 142 to clock CPU 12 at 1.4 Ghz.

In additional embodiments, windows 169, 172, 175 and 178 may be used for other values. For example, window 169, associated with CPU temperature component 133, may be used to enter a maximum or minimum temperature at which the user desires CPU 12 to operate. The position of slider 157 in operating status window 145 may then be used to graphically indicate the meaning of the temperature assigned in the operating range of CPU 12, e.g., is the selected temperature setting high or low as compared to a normal CPU operating temperature.

Window 172, for example, associated with noise component 136, may be configured to permit a user's entry of a numeric decibel value which the user desires information handling system 10 not exceed. In one embodiment, noise component 136 and adjustments thereto may affect operation of an information handling system fan (not expressly shown), either by controlling the speed at which the fan turns, the number of fans used at any one time, or otherwise.

Window 175, associated with battery life component 139 may also be implemented in a variety of ways. In one implementation, window 175 may permit a user to enter a number representing the number of hours the user wishes the battery to last. In an alternate implementation, window 175 may permit a user to enter a value between one (1) and one-hundred (100) representing the minimum and maximum battery lives, respectively. A user entry of one hundred (100), for example, may suggest the user wants to maximize battery life. In response, software or hardware associated with battery life component 139, such as advanced power management (APM) utilities and power management chip set 74, may change one or more power management settings in information handling system 10 directed to achieve the user's desired results. For example, adjustment of battery life component 139 may affect its related or operationally linked components by reducing system performance 142, increasing the temperature at which CPU temperature component 133 is set so that the system fan comes on less frequently, etc.

In one implementation of teachings of the present disclosure, movement of one of sliders 157, 160, 163 and 166 may result in the substantially simultaneous movement of the remaining sliders. For example, if a user were not concerned about the length of life of battery 62 in information handling system 10, the user may reposition slider 163 to the lowest setting for battery life component 139. As a result of the relationships or operational links between temperature component 133, noise component 136, battery life component 139 and performance component 142, the movement of slider 163 may result in a substantially simultaneous movement of slider 157 upwards towards a high value, slider 160 may keep the noise component at its high value and slider 166 may increase to reflect the permission given by the low battery life user preference setting indicating that the overall performance of information handling system 10 may be increased at the cost of reduced battery life.

In another embodiment, a user may be able to lock the settings assigned to one or more of components 133, 136, 139 and 142 through the use of check boxes 181, 184, 187 and 190, respectively. By locking the operating status or user preference setting of one or more selected components, a user may constrain their ability to alter the operating status of the components related to the one or more locked components. For example, locking CPU temperature component 133 at the level indicated by slider 157, noise component 136, generally associated with the cooling system (not expressly shown) of information handling system 10, may consequently be limited in its range of available settings to ensure that the locked CPU temperature component 133 setting may be achieved and thereafter maintained. In other words, in order to maintain temperature component 133 in a reduced temperature state, the cooling system of information handling system 10 may need to remain operational at a maximum or near maximum level which may thereby require that noise component 136 remain at or near its highest available state, as indicated by the position of slider 160 in 148.

In a further embodiment, a user may be able to effect user preference settings through the selection of one or more of a plurality of information handling system 10 operating modes. For example, a user may be presented with optional information handling system 10 operating modes including, but not limited to, a travel mode, a gaming mode, a movie mode, productivity mode, etc. In response to user selection of gaming mode, for example, a graphical user interface may be presented which communicates to the user the components affected by setting information handling system 10 to operate in gaming mode, e.g., the components of performance, noise, temperature, display characteristics and battery life, may be affected. In the gaming mode user preference setting graphical user interface, default settings for each of the affected components may also be presented to the user to inform the user of the effects of entering the gaming mode. In such an embodiment, the capability to adjust operational aspects of one or more components may also be included. Alternatively, a user change to a component configuration of a defined operating mode may remove the system from the selected operating mode to a user customized set of user preference settings.

As mentioned above, the user may be prompted to accept desired changes to the operational status of one or more of the information handling system 10 components. A user may accept their user preference settings in graphical user interface 130 using OK button 193. Button 193 may further permit the user to exit or escape from the user preference setting utility depicted by graphical user interface 130. Through user selection of cancel button 199, the user may exit from user preference setting graphical user interface 130 without effecting or implementing changes associated with user manipulation of one or more of component control sliders 157, 160, 175 and 178. As mentioned above, graphical user interface 130 may be alternatively implemented. For example, sliders 157, 172, 163 and 166 may be replaced with dials, resource meters, as well as other user input or indicator mechanisms.

Alternative embodiments of the present disclosure include computer-usable media encoding logic such as computer instructions for performing the operations of methods 90 and 100. Such computer-usable media may include, without limitation, storage media such as floppy disks, hard disks, CD-ROMs, read-only memory, and random access memory; as well as communications media such as wires, optical fibers, microwaves, radio waves, and other electromagnetic or optical carriers. The control logic may also be referred to as a program product.

Although the disclosed embodiments have been described in detail, it should be understood that various changes, substitutions and alterations can be made to the embodiments without departing from their spirit and scope.

1. A method for communicating the consequences of a user preference setting on related components, comprising:
displaying a component control for a selected component, the component control operable to effect a user preference setting concerning the selected component; and
displaying an operating status for a component related to the selected component, the operating status of the related component resulting from effecting the user preference setting on the selected component.

2. The method of claim 1, further comprising displaying an operating status for the selected component and each related component, the operating status of each component reflecting the consequences of effecting the user preference setting on the selected component.

3. The method of claim 1, further comprising determining the operating status of a related component resulting from effecting the user preference setting on the selected component based on user defined component relationships.

4. The method of claim 1, further comprising determining the operating status of a related component resulting from effecting the user preference setting on the selected component based on component behavior observed during operation of the information handling system.

5. The method of claim 1, further comprising displaying a plurality of component controls, each of the plurality of component controls corresponding to a respective component and operable to effect a user preference setting on its respective component.

6. The method of claim 1, further comprising:
displaying an operating status for a plurality of related components;
displaying a component control for at least one of the related components; and
adjusting the operating status of the plurality of related components substantially simultaneously with an adjustment of the component control.

7. The method of claim 1, further comprising communicating the user preference setting to a device manager, the device manager operable to adjust operation of the selected component in accordance with the user preference setting.

8. An information handling system, comprising:
a memory;
a processor operably coupled to the memory;
a plurality of components operably coupled to the memory and the processor, each component having an operating status;
a display device operably coupled to the memory and the processor; and
a program of instructions storable in the memory and executable by the processor, the program of instructions operable to display the operating status for a first component, receive a desired modification in operation for the first component, determine the operating status for each operationally linked component resulting from the modification in operation for the first component, and display on the display device the operational status for the first component and at least one operationally linked component.

9. The information handling system of claim 8, further comprising the program of instructions operable to define the operational links between components.

10. The information handling system of claim 9, further comprising the program of instructions operable to ascertain configuration of the information handling system to define the operational links between components.

11. The information handling system of claim 9, further comprising the program of instructions operable to define the operational links between components in accordance with user supplied parameters.

12. The information handling system of claim 9, further comprising the program of instructions operable to calculate the effects resulting from the modification in operation according to the defined operational links.

13. The information handling system of claim 9, further comprising the program of instructions operable to lock the operating status of at least one component such that modification of one or more related components is limited by the defined operational links and the operating status of the locked component.

14. The information handling system of claim 8, further comprising the program of instructions operable to display a plurality of performance controls, the performance controls operable to effect a modification in operation of an associated component and display the operating status for one or more components related to each performance controls.

15. The information handling system of claim 8, further comprising the program of instructions operable to implement the modification in operation.

16. The information handling system of claim 8, further comprising the program of instruction operable to substantially simultaneously display the operating status for the first component, receive the desired modification in operation for the first component, and display on the display device the operational status for the first component and at least one operationally linked component.

17. The information handling system of claim 8, further comprising the performance control representing a component control for a software module, the software module responsible for controlling a plurality of operationally linked component parameters.

18. A computer program, stored on a tangible storage medium, for use in communicating the effects of user preference settings in an information handling system, the program including executable instructions that cause a computer to:
define relationships between a plurality of information handling system components;
display at least one performance control, the performance control operable to effect at least one desired change in operation of a configurable information handling system component;
receive, through the at least one performance control, a desired change in operation of the configurable information handling system component;
calculate, based on the defined relationships, effects on one or more related information handling system components resulting from the desired change in operation of the configurable information handling system component; and
display an operating status for the related information handling system components resulting from effecting the desired change.

19. The computer program of claim 18, further operable to display a performance control for each configurable information handling system component.

20. The computer program of claim 19, further operable to simultaneously display the operating status of each information handling system component related to the configurable information handling system components.

21. The computer program of claim 18, further operable to define the relationships between the plurality of information handling system components based on performance data for the current information handling system configuration.

22. The computer program of claim 18, further operable to selectively fix the operating status of one or more configurable information handling system components.
